(19) United States
(12) Patent Application Publication
(10) Pub. No.: US 2023/0360436 A1
(43) Pub. Date: Nov. 9, 2023

(54) SYNTHETIC MASKED BIOMETRIC SIGNATURES

(71) Applicant: REALNETWORKS, INC., Seattle, WA (US)

(72) Inventor: Milko BOIC, Seattle, WA (US)

(21) Appl. No.: 17/947,955

(22) PCT Filed: Apr. 7, 2021
(86) PCT No.: PCT/US2021/026211

§ 371 Date: Sep. 19, 2022

Related U.S. Application Data
(60) Provisional application No. 63/008,526, filed on Apr. 10, 2020.

(51) Int. Cl. G06V 40/16; G06V 10/26; G06V 10/44; G06V 10/82

(52) U.S. Cl. CPC G06V 40/172; G06V 40/171; G06V 40/165; G06V 10/26; G06V 10/44; G06V 10/82

(57) ABSTRACT

Systems and methods for processing images of a person wearing a mask or where their face is otherwise partially covered. A first face image of a person is received, such as from a camera. A mask image is combined with the first face image to obtain a second face image. A first biometric signature is generated for the second face image and stored in associate with identification information for the person. The first biometric signature is then used to identify the person in subsequent images

### BACKGROUND

### Technical Field

The present disclosure relates to systems and methods for processing facial images.

### Description of the Related Art

Some processor-based systems are configured to process images for recognizing objects, persons, places, animals, or other such subjects depicted in the images. Such systems face numerous obstacles regarding how images are collected and processed to recognize subjects in the images obtained. Some of these systems may process information related to previous images in order to recognize or identify the subject depicted in another image. However, it may be difficult for such systems to recognize a subject having a different appearance relative to a previously captured appearance of the subject.

### BRIEF DESCRIPTION OF THE SEVERAL VIEWS OF THE DRAWINGS

For a better understanding of the embodiments, reference will now be made by way of example to the accompanying drawings. In the drawings, identical reference numbers identify similar elements or acts. The sizes and relative positions of elements in the drawings are not necessarily drawn to scale. For example, some of these elements may be enlarged and positioned to improve drawing legibility.

FIG. 1 is a diagram of an environment in which modalities of face images are learned and matched;

FIG. 2 is an environment in which one or more biometric signatures are generated of a face image;

FIG. 3 is an environment in which a defined region of a face image is identified;

FIG. 4A is a diagram of an object image to be combined with the face image;

FIG. 4B is a diagram in which the object image is combined with the face image;

FIG. 5 is a diagram of a first process in which a system identifies a person based on a comparison involving one or more biometric signatures;

FIG. 6 is a diagram of a second process in which a system identifies a person based on a comparison involving one or more biometric signatures;

FIG. 7 is a method in which a biometric signature of a modified face image is generated;

FIG. 8 is a method in which a biometric signature of a face image is assessed for facial recognition processing; and

FIG. 9 is a method in which a biometric signature of a face image is compared with a plurality of stored signatures.

### DETAILED DESCRIPTION

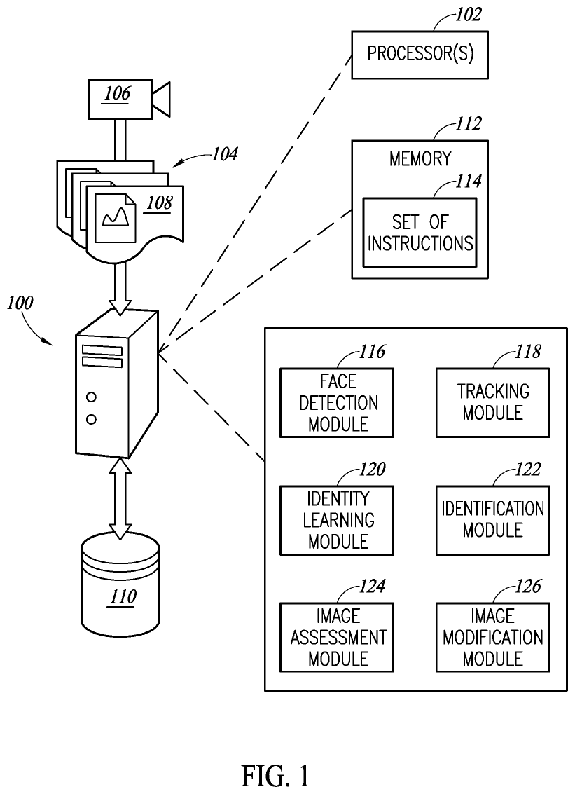

FIG. 1 shows a system 100 for image-based authentication according to one or more embodiments. The system 100 is configured to recognize or identify persons based on an unobstructed facial image captured, the unobstructed facial image being one in which the subject is not wearing equipment that obstructs the face. The system 100 is also configured to recognize the subject in a facial image captured of the subject who is wearing equipment that obstructs the face based on the unobstructed facial image.

In a facial recognition system that processes images depicting faces, some systems may accurately recognize front views of faces, but may have trouble distinguishing between different modalities of the subject. Some systems may have difficulty distinguishing an unobstructed view of a face from a view of the same face wearing protective equipment. For example, an image may be captured of a subject at a first time and used to identify the subject. It may be problematic for the system to identify the subject if the subject has a different appearance due to equipment or accessories worn by the subject. Although it may be possible to capture images of the subject wearing various articles of equipment for use in identifying the subject, this may complicate the process of registering the identity of the subject. Moreover, it may be difficult to anticipate what equipment the subject may wear and numerous sessions may be necessary to complete the process to register each appearance. It is thus impractical to collect and process all possible appearances of a subject.

Determining what previous images to process or store is also a challenging problem. Overinclusion of image information may impede the processing efficiency of the system or occupy a significant amount of data storage space. On the other hand, underinclusion of image information may adversely affect the robustness and accuracy of the system. In systems in which an appropriate amount of image information is obtained for subject recognition, it may be difficult for the system to appropriately process different views or appearances of the same subject in recognition processing. Some systems are insufficiently configured to obtain and process different modalities of subjects.

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

References to the term “set” (e.g., “a set of items”), as used herein, unless otherwise noted or contradicted by context, is to be construed as a nonempty collection comprising one or more members or instances.

References to the term “subset” (e.g., “a subset of the set of items”), as used herein, unless otherwise noted or contradicted by context, is to be construed as a nonempty collection comprising one or more members or instances of a set or plurality of members or instances. Moreover, the term “subset,” as used herein, refers to a collection of one or more members or instances that are collectively smaller in number than the set or plurality of which the subset is comprised. For instance, a subset of a set of ten items will include less than ten items and at least one item.

References to the term “module,” as used herein, is to be construed as a collection of hardware configured to perform a set of particular computing functions within a system. The hardware of a module may include one or more processors that are specifically hardwired to perform one or more of the set of particular computing functions. A module may be a set of instructions that, as a result of execution by a processor, causes the processor and associated hardware to perform one or more of a set of particular functions.

With reference to FIG. 1, the system 100 includes one or more processors 102 that cause the system 100 to perform one or more operations described herein. The system 100 receives a plurality of images 104 from a camera 106 and determines how to process individual images 108 of the plurality of images 104 received. The system 100 may process an image 108 to determine whether to store the image 108 or a portion thereof in data storage 110 for future subject recognition purposes. The system 100 may also determine how to evaluate the image 108 or a portion thereof to identify or recognize a subject in the image. A subject of the image 108 refers to a person or an object depicted therein. The present disclosure describes the subject as being a face of a person depicted in one or more images 108 of the plurality of images 104. However, those of ordinary skill in the art will understand that the technology discussed herein may extend to other subjects, such as merchandise, packages, animals, and location, by way of non-limiting example.

The system 100 may include memory 112 storing a set of instructions 114 that, as a result of execution by the one or more processors 102, cause the system 100 to perform as described herein. The memory 112 may include volatile memory (e.g., random-access memory) and/or non-volatile memory (e.g., read-only memory) for storing data and instructions. In some embodiments, the one or more processors 102 may include a device having hardware specifically configured to perform at least some of the operations described herein. For instance, the one or more processors 102 may include application specific integrated circuits (ASICs), field programmable gate arrays (FPGAs), system-on-a-chip (SoC), or other specialized or customizable computing hardware hardwired to perform at least some of the operations described herein.

The camera 106 may be part of the system 100 or may be considered to be a component separate from the system 100. The camera 106 is electrically communicatively coupled to the system 100 and provides the plurality of images 104 as an input to the system 100. The camera 106 may be directly coupled to the system 100 via a wired connection or may be remotely coupled to provide the plurality of images 104 to the system 100, for example, over a wired or wireless communication network. In some embodiments, a plurality of cameras 106 coupled to the system 100 may each provide a plurality of images 104 to the system 100. Although the plurality of images 104 are shown as being received from the camera 106, the plurality of images 104 may be received from a source other than the camera 106. For instance, the plurality of images 104 may be received over a network (e.g., local area network, wide area network) and/or via an intermediate device, such as a network router or a server. In some instances, the plurality of images 104 may be stored in memory at a first time and provided to the system 100 at a second time later than the first time.

The system 100 may also include a set of modules for performing various operations described herein. The system 100 may include a face detection module 116 for detecting one or more faces of persons depicted in an image 108 or the plurality of images 104. The system 100 may include a tracking module 118 for tracking a face of a person between sequential images 108 of the plurality of images 104. For example, the tracking module 118 may track a face of a particular person across sequential images 108 in video media. The system 100 may also include an identity learning module 120 that learns identities of persons depicted in an image 108. In some embodiments, the identity learning module 120 causes the system 100 to store, in the data storage 110, information regarding a plurality of modalities represented in different images 108 with an identity, as describe below. The system 100 may also include an identification module 122 that identifies a person represented in an image 108 based on biometric signature information stored in the data storage 110. In some embodiments, the identification module 122 causes the system 100 to identify a person depicted in an image 108 based on a proximity threshold corresponding to a modality of the person's face in the image 108. The system 100 may further include an image assessment module 124 that assesses various characteristics of face images captured to determine whether the characteristics of the face images are appropriate for identity processing, such as learning or updating information associated with an identity stored in the data storage 110 or appropriate to recognize the identity of a person in the face image.

The system 100 includes an image modification module 126 that modifies an image obtained from the camera 106 or stored in the data storage 110 to generate a modified image. The image modification module 126 may modify an image by combining the image with another image. For example, the image modification module 126 may superimpose or overlay one image over another image. The image modification module 126 may be configured to identify a certain region within an image to be modified and modify the region identified. The image modification module 126 may include or have access to a neural network that is trained to identify the certain region of the image.

The face detection module 116, the tracking module 118, the identity learning module 120, and the identification module 122 are described as being distinct modules. In some embodiments, two or more of the modules may be combined into a single module that performs the corresponding operations for the respective modules without departing from the scope of the instant disclosure. Some or all of the face detection module 116, the tracking module 118, the identity learning module 120, and the identification module 122 may operate according to machine learning principles by, for example, implementing neural network models or artificial intelligence models to perform their respective operations. As one example, the identity learning module 120 may be generated or trained via supervised or unsupervised learning principles to generate biometric signatures of a face image to evaluate modalities corresponding to the face images in view of a threshold. As another example, the identification module 122 may be generated or trained via supervised or unsupervised learning principles to identify a person in a face image based on a comparison of biometric signatures in view of a threshold determined based on an evaluation of the face image.

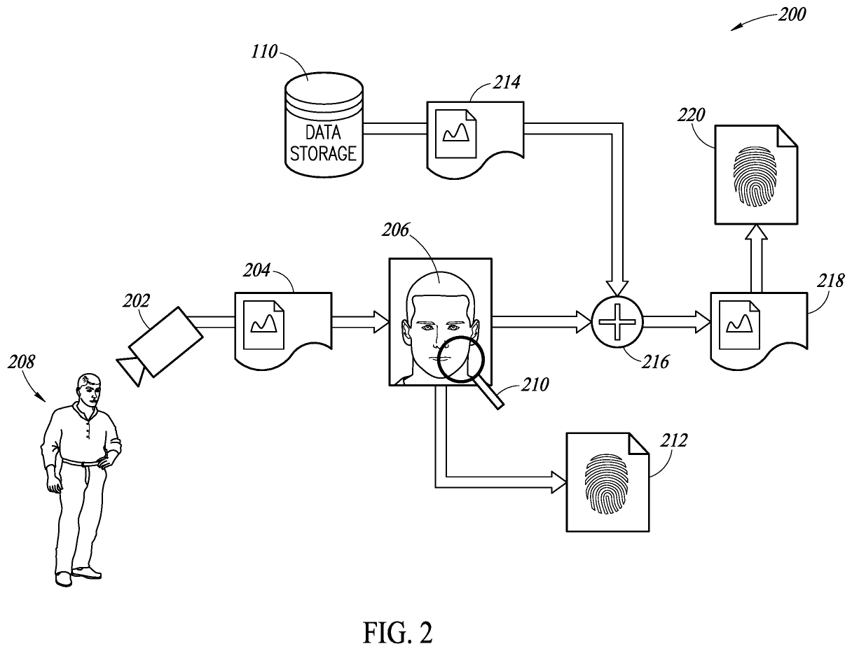

FIG. 2 shows an environment 200 in which the system 100 operates to generate biometric signatures of a face of a subject according to one or more embodiments. The system 100 may associate multiple modalities of a person with an identity stored in the data storage 110. In the environment 200, a camera 202 captures an image 204 that includes a face image 206 of a person 208 and that may include other features, such as a portion of the body of the person 208 or an ambient environment. The person 208 may be attempting to gain access a restricted physical area or gain access to restricted electronic data, for example.

The image 204 is provided to the system 100, which processes the image 204. The face detection module 116 may detect the face image 206 in the image 204 based on knowledge-based methods, feature invariant methods (e.g., feature extraction), template matching methods, or appearance-based training methods. The face detection module 116 may be trained or generated by receiving a set of training data and determining correlated relationships between face images and non-face images. The face detection module 116 may identify the face image 206 in the image 204 and extract or generate image data corresponding to the face image 206.

The system 100 may then perform an assessment 210 of the face image 206 to determine whether characteristics of the face image 206 satisfy a set of criteria for processing face images. The system 100 performs the assessment 210 of the face image 206 based on a set of factors and generates image assessment information for the face image 206 based on a result of the assessment. The face image 206 may be evaluated based on image characteristics as well as content of the face in the face image 206. The set of factors may include one or more of a size of the face image 206, a pose of a face in the face image 206, sharpness of the face image 206, and contrast quality of the face image 206. Further description of the assessment 210 and other analysis regarding the face image 206 is described elsewhere herein. Further description of various features herein are described in U.S. patent application Ser. No. 16/262,590, filed Jan. 30, 2019; and in U.S. Patent Application No. 62/830,331, filed Apr. 5, 2019, the entirety of which disclosures are incorporated herein by reference.

The assessment 210 includes determining whether a particular region of a face is present in the face image 206. The particular region of the face image 206 detected by the system 100 may be a region including the mouth, a portion of the nose, and portions of the cheeks, as described herein. As a result of determining that the particular region is present in the face image 206, the system 100 may identify the particular region. Identifying the particular region may include identifying coordinates within the image that define the particular region. The system 100 may include a neural network that is trained to identify the particular region of the face image 206.

As a result of the face image 206 satisfying the assessment 210, the system 100 may generate a biometric signature 212 of the face image 206. In some embodiments, the biometric signature 212 is a face template having features corresponding to features of a subject's face. The biometric signature 212 may be the output of a neural network or other machine learning model implemented by the system 100. The biometric signature 212 may be a multidimensional array or vector representative of features of the face depicted in the face image 206. The multidimensional array or vector may include a plurality of values representative of the features, and may be representative of distinctions between features, such as distances between features or differences in image characteristics, such as contrast, sharpness, etc.

One example of a multidimensional vector corresponding to a biometric signature may be sets of values that respectively correspond to particular areas of a face depicted in a face image. The particular areas may be regions around each eye, the nose, the mouth, the chin, or portions of the foregoing features, such as corners of the mouth, the bridge of the nose, or the tip area of the nose. Each of the set of values may be representative of characteristics of a corresponding area of the face, such as sizes of the area or features therein or distances between features in each area. Another example of a multidimensional vector corresponding to a biometric signature may be sets of values corresponding to geometric features of a face depicted in a face image. Features, such as pupil centers, nose tip, and mouth corners, may be identified in the face image and distances and directions between the features may be determined. Such distances and directions may be included as sets of values comprising the multidimensional vector. These examples of multidimensional vectors and processes for generating multidimensional vectors are non-limiting and other examples of multidimensional vectors may apply to the current description without departing from the scope of the present disclosure.

In some embodiments, multidimensional vectors may be generated according to a machine learning model that is trained to generate an output using samples as input. The machine learning model may iteratively adjust weights and/or biases to minimize error in the output. The machine learning network may include a neural network having a plurality of layers, including one or more hidden layers, an input layer, and an output layer. The machine learning model may be trained according to supervised learning principles, unsupervised learning principles, or semi-supervised learning principles.

The system 100 may store the biometric signature 212 in data storage 110 for use in future subject identification. The biometric signature 212 may be associated in data storage 110 with an identity of the corresponding person 208. For instance, the system 100 may store the biometric signature 212 in association with a unique identifier corresponding to the person (e.g., employee identification number, name, known traveler number, social security number). In situations in which a previously-generated identity is not stored in the data storage 110, the system 100 may create a new identity with a unique identifier for the person. In some embodiments, the face image 206 may also be stored in association with the unique identifier.

The system 100 also obtains an image 214 from data storage 110 to be combined with the face image 206. The image 214 is an image of equipment designed to be worn on the particular region of the user's face. For instance, the image 214 may be an image of personal protective equipment, such as a mask, respirator, goggles, shield, or other such face piece, that covers the particular region of the user's face in the face image 206. The image 214 may be an image captured of the personal protective equipment while worn on the face of another person such that features of the image 214 indicate the presence of the particular region beneath. For the particular example of a face mask (e.g., N95 mask), the image 214 may be an image of the face mask worn on the face of another person. The image 214 may be an image selected from a plurality of other similar images based on facial characteristics of the face image 206, such as a size of the nose, eyes, width of the face, or height of the face, by way of non-limiting example. The image 214 may be selected based on the similarity of the facial characteristics of the face image 206 to the other person wearing the equipment.

The system 100 performs a procedure 216 in which the face image 206 and the image 214 are combined or merged to generate a modified image 218. The image 214 may be superimposed or overlaid on the particular region of the face image 206 identified in the assessment 210. The image 214 may be modified to conform to the face shown in the face image 206, such as by resizing, fitting, cropping, orienting, stretching, compressing, or otherwise manipulating the image 214 to cover the particular region and correspond to the features shown in the particular region identified in the face image 206. Once the image 214 is modified, if appropriate, and superimposed on the face image 206, an image of the face image 206 with the combined image 214 overlaid thereon is captured and the resulting modified image 218 is stored in memory of the system 100 (e.g., the data storage 110). Then, the system 110 generates a biometric signature 220 of the modified image 218, as described herein. The biometric signature 220 is stored in the data storage 110 in association with the identity of the person 208. The biometric signature 220 may be stored as a supplemental or alternate signature for identifying or verifying the authenticity of the person 208 based on presentation of an image of the person 208.

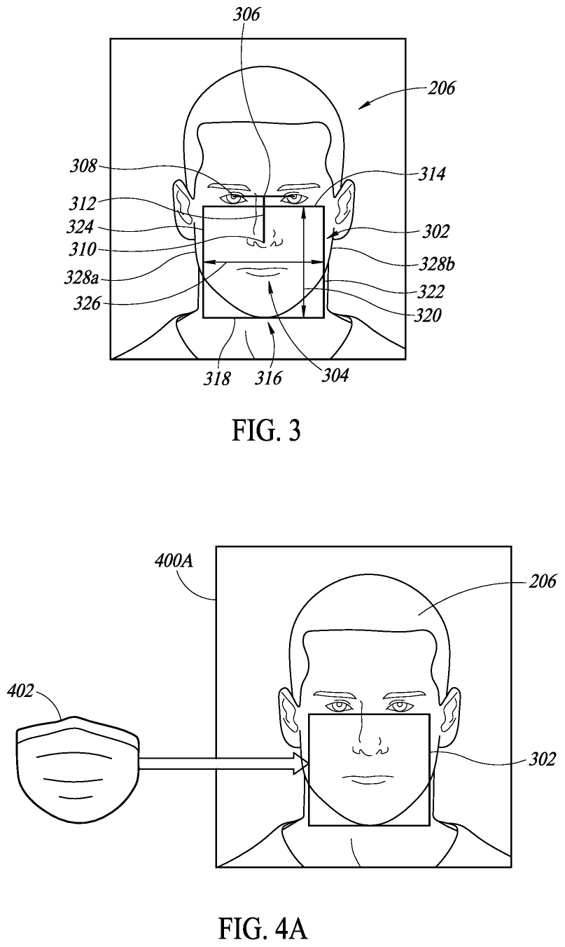

FIG. 3 shows a region of the face image 206 identified by the system 100 according to one or more embodiments. The region 302 identified may be covered or occluded when the person 208 wears certain protective equipment. The region 302 shown in FIG. 3 includes a mouth 304, a portion of the nose, and portions of the cheeks that are covered when the person 208 wears a respiration mask (e.g., N95 mask) or a respirator. However, other regions of the face image 206 may be identified for other types of protective equipment. For example, a region around the eyes may be identified in connection with protective goggles to be worn by the person 208.

The region 302 is identified in connection with identifying certain features in the face image 206 and determining various relationships between features identified. For the region 302, the system 100 identifies a bridge 306 of the nose, which may be a portion of the nose between pupils or pupil centers 308 of the eyes in the face image 206. The system 100 also identifies a tip 310 of the nose and determines a line 312 extending between the bridge 306 and the tip 310. A position of an upper boundary 314 of the region 302 along the line 312 is determined based on a defined ratio, percentage, or other relationship. The position of the upper boundary 314 is one-third or 33% of the distance from the bridge 306 to the tip 310 along the line 312 in FIG. 3; however, this ratio may be different in some circumstances.

The system 100 also identifies a chin 316 of the face image 206 and determines a position of a lower boundary 318 of the region 302 relative to the chin 316. For instance, the lower boundary 318 may be positioned at or around the chin 316. The lower boundary 318 extends in a direction parallel to the upper boundary 314. The region 302 has a first dimension 320 (e.g., height) between the upper boundary 314 and the lower boundary 318.

The system 100 determines positions of a first side boundary 322 and a second side boundary 324 of the region 302 based on a width of the face image 206. The system 100 may determine that a second dimension 326 of the region 302 is a defined ratio or percentage of the width of the face image 206. For instance, the system 100 may determine the width of the face in the face image 206 as being a widest portion of the face between cheeks 328a and 328b. The second dimension 326 may be determined as being, for example, 80% of the distance between a widest portion of the face at the cheeks 328a and 328b. The first side boundary 322 may be determined as being a line extending between the upper and lower boundaries 314 and 318 at a distance from the line 312 that is half of the second dimension 326. The second side boundary 324 may be determined as being a line extending between the upper and lower boundaries 314 and 318 at a distance from the line 312 that is half of the second dimension 326 on a side of the line 312 opposite to the first side boundary 322.

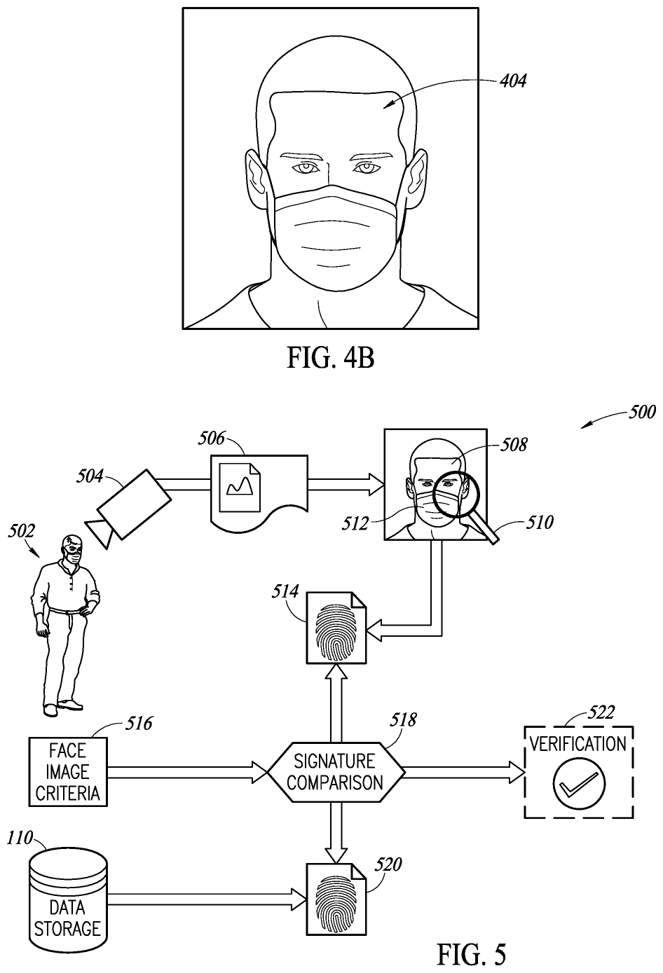

FIG. 4A shows an environment 400 in which the system 100 generates a modified image according to one or more embodiments. In particular, the system 100 obtains an image 402 from data storage 110 to be combined with the face image 206. The image 402 obtained is an image of a respiration mask or a respirator designed to be worn over the region 302 of the face identified by the system 100. The image 402 obtained may be selected from among a plurality of images based on characteristics of the face in the face image 206. For example, the image 402 may be selected based on the width of the face, the length of the line 312, or a distance between the nose tip 310 and the chin 316, by way of non-limiting example. The system 100 combines the face image 206 and the image 402 to generate a modified image 404, as shown in FIG. 4B. The image 402 is superimposed or overlaid upon the region 302 identified in the face image 206. In some implementations, the image 402 or portions thereof may be manipulated (e.g., resized, warped, distorted) to fit the image 402 to the face image 206. The system 100 generates a biometric signature of the modified image 404 and stores the biometric signature in data storage 110 for use in identifying or authenticating an identity of a person at a later time.

In some embodiments, the system 100 may include or have access to a neural network that superimposes an appropriate image on the face image 206. For instance, the system 100 may include a generative adversarial network (GAN) or a variational autoencoder (VAE) trained to identify the region 302 of the face image 206 and generate an image depicting protective equipment (e.g., a respiration mask, respirator) on the region 302. Such neural networks may be trained via a discriminative neural network to generate new data instances that modify previously obtained images.

FIG. 5 shows a diagram 500 in which a person 502 wearing protective equipment is identified or authenticated by the system 100 according to one or more embodiments. A camera 504 captures an image 506 of the person 502 wearing protective equipment and a face image 508 of the person 502 is identified or extracted. The system 100 performs an assessment 510 of the face image 508 and determines that the face image 508 includes protective equipment 512.

In some implementations, prior to performing the comparisons 518, the face image 508 may be assessed in terms of various criteria to ensure that it is of sufficient quality to confidently determine a match. The assessment 510 may involve assessment of the size of the face image 508, the pose or orientation of the face in the face image 508, the sharpness of the face image 508, and/or the contrast quality of the face image 508. The system 100 may generate image assessment information based on the result of the assessment 510 and evaluate the image assessment information to determine whether to advance the face image 508 for further processing.

As a result of determining that the face image 508 includes the protective equipment 512 worn on the face of the person 508, the system 100 uses a set of face image criteria 516 to authenticate the person 502. The face image criteria 516 includes a set of criteria corresponding to the aforementioned set of factors—namely, criteria regarding one or more of the size of the face image 508, the pose of the face in the face image 508, the sharpness of the face image 508, and the contrast quality of the face image 508. The set of criteria may specify a different threshold or condition corresponding to each of the set of factors.

More particularly, the face image criteria 516 may include thresholds or criteria related to a minimum standard for number of pixels between center distances between the centers or pupils of eyes, a minimum standard for center pose quality of the face, a minimum standard for face sharpness quality, or a minimum standard for face contrast quality. These criteria may have stricter standards for assessing a face image 508 including protective equipment relative to standards that would be used for assessing a face image without protective equipment.

In practical application, as a result of a determination by the system 100 that the face image 508 is a sufficient size, a center pose quality, sharpness quality, and contrast quality and it is determined to be occluded by protective equipment, the system 100 will perform comparisons 518 between the face distance required against masked biometric signatures will be stricter (smaller) than the match against a full face biometric signature. This may help to facilitate a reduction in false negative rates and help to facilitate better matching rates for individuals with more prominent differentiating characteristics in eye region. If the

The system 100 generates a biometric signature 514 of the face image 508. The system 100 performs signature comparisons 518 between the biometric signature 514 and one or more biometric signatures 520 stored in the data storage 110. Some or all of the biometric signatures 520 stored in the data storage 110 may be based on modified face images generated by combining a face image with an image of protection equipment, as described herein. For each comparison 518, the system 100 may compare distances between the biometric signature 514 and the stored biometric signatures 520 and determine a match based on a similarity of the signatures, such as a cosine similarity or other similarity measure.

The face image criteria 516 include different criteria or thresholds than would be used in authentication of a face without protective equipment or that includes a different type of protective equipment. As one example, the face image criteria 516 may include thresholds or criteria related to distances between biometric signatures that is stricter or smaller than face image criteria that would be used for a face image that does not include protective equipment.

For each comparison 518, the system 100 may obtain a stored biometric signature 520 from among the stored biometric signatures in the data storage 110 and determine whether the stored biometric signature 520 matches the biometric signature 514 for the face image 508 being evaluated. A determination that the biometric signature 514 is a match for the stored biometric signature 520 may involve a determination that the biometric signature 514 satisfies a similarity criterion with respect to the stored biometric signature 520. The system 100 may identify or authenticate the identity 522 of the person depicted in the face image 508 as corresponding to the identity associated with the stored biometric signature 520 based on the signature comparison 518. If the biometric signature 514 is not a match for the stored biometric signature 520, the system 100 may perform additional signature comparisons 518 with biometric signatures of the stored biometric signatures until the system 100 determines a match or is unable to match the biometric signature 514 with any of the stored biometric signatures.

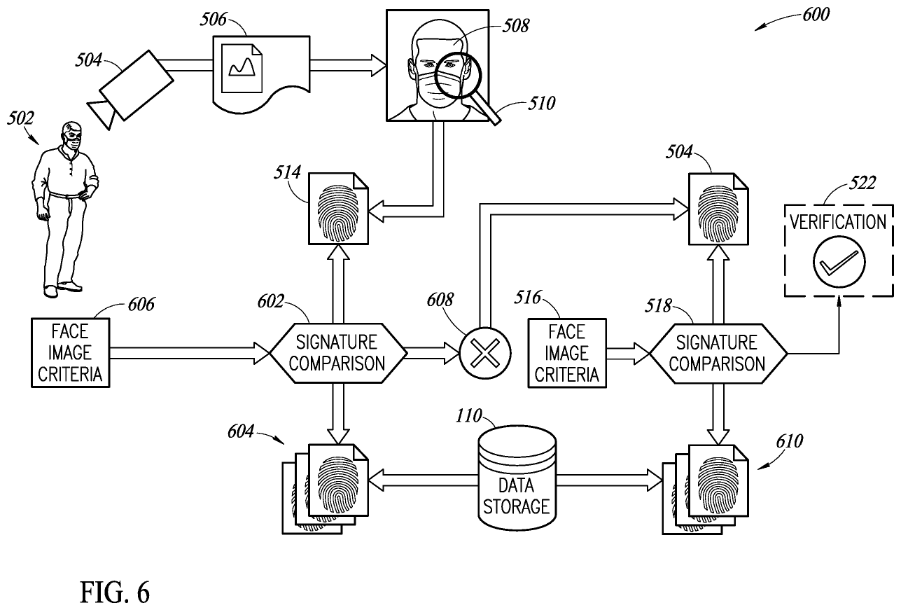

FIG. 6 shows a diagram 600 in which the person 502 wearing protective equipment is identified or authenticated by the system 100 according to one or more embodiments. The diagram 600 includes several features that are substantially similar to the diagram 500, so further description thereof is omitted for brevity. The camera 504 captures the image 506 of the person 502 wearing protective equipment. The system 100 may not detect whether the face image 508 includes the protective equipment 512 in the assessment 510 performed on the face image 508 in the diagram 600. In the diagram 600, the system 100 evaluates the face image 508 based on a set of face image criteria 606 used for assessing face images that are not occluded or that do not include the protective equipment 512.

The system 100 may assess the face image 508 using the face image criteria 606 regarding one or more factors, such as the size of the face image 508, the pose of the face in the face image 508, the sharpness of the face image 508, and the contrast quality of the face image 508. The face image criteria 606 may include thresholds that are less strict than would be used to assess a face image detected as including the protective equipment 512. As a result of determining that the face image 508 satisfies the minimum standards for evaluation, the system 100 generates the biometric signature 514 of the face image 508 and performs signatures comparisons 602 between the biometric signature and stored biometric signatures 604 stored in the data storage 110. The biometric signatures 604 stored in the data storage 110 are biometric signatures of face images that do not include protective equipment.

The system 100 compares 602 the biometric signature 514 with the biometric signatures 604 and determines, at 608, that the biometric signature 514 is not a match with any of the biometric signatures 604. Thereafter the system 100 performs the signature comparisons 518 with biometric signatures 610 stored in the data storage using face image criteria 516, as discussed with respect to FIG. 5. In connection with or as a prerequisite to the signature comparisons 518, the system 100 may assess characteristics of the face image 508 using the criteria factors discussed above to determine whether the face image 508 satisfies certain standards sufficient to authenticate the face image 508 using biometric signature comparison. Such criteria include factors regarding one or more of the size of the face image 508, the pose of the face in the face image 508, the sharpness of the face image 508, and the contrast quality of the face image 508.

The biometric signatures 610 are biometric signatures of face images that include protective equipment, such as respiration masks or respirators. The face image criteria 516 used to evaluate signature comparisons 518 between the biometric signature 514 and the biometric signatures 610 are different than the base image criteria 606 used to evaluate biometric signatures that do not include protective equipment. For example, the face image criteria 516 may be more strict or may have higher thresholds that are involved in evaluating the signature comparisons 602. As a result of determining that the biometric signature 514 is a match with 1 of the biometric signatures 610 in view of the face image criteria 516, the system 522 identifies or verifies the authenticity of the person 502. Identification 522 of the person 508 may include providing information regarding an identity associated with the biometric signature of the biometric signatures 610 matching the biometric signature 514.

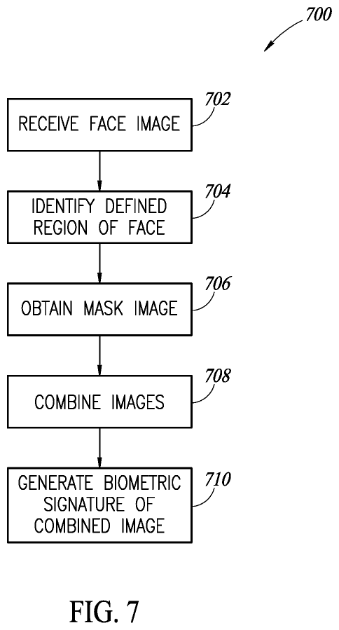

FIG. 7 shows a method 700 generating a biometric signature of a modified image according to one or more embodiments. The method 700 is performed by the system 100 as described with respect to the environment 200 in FIG. 2 and elsewhere herein. The method 700 includes receiving 702 a face image of a person who is not wearing protective equipment. Receiving 702 the face image may include receiving an image, such as the image 204 of FIG. 2, and extracting or identifying a face image within the image. The face image may be received from a camera coupled to the system 100 or received from an external system requesting identification or authentication of a person shown in the face image. The face image, for example, may be received over one or more networks, such as the Internet or Local Access Network.

At 704, the method 700 includes identifying a defined region of the face in the face image. The defined region identified in 704 is based on a type of protective equipment that the person may be expected to wear. Medical professionals may be expected to wear respiration masks or respirators, so the region identified ion 704 may be the region 302. However, other regions may be identified in 704 based on different circumstances.

The method 700 also includes obtaining 706 an image of protective equipment from data storage to be combined with the face image received in 702. The image obtained in 706, for example, may be the image 402 of the mask of FIG. 4A. The method 700 also includes combining 708 the face image received in 702 and the protective equipment image obtained in 706, as discussed with respect to 216 of FIG. 2 to obtain the modified image 218. Combining 708 includes overlaying or superimposing the image obtained in 706 over the region identified in 704. In some embodiments, combining 708 the images may be performed by a neural network (e.g., GAN, VAE) that is trained to modify the face image to include a worn article of protective equipment.

The method 700 also includes generating 710 a biometric signature of the modified face image generated in 708. The biometric signature may be generated in 710 by a neural network that is included in or accessible by the system 100. The biometric signature generated in 710 may then be stored in the data storage 110 for identifying the person at a later time.

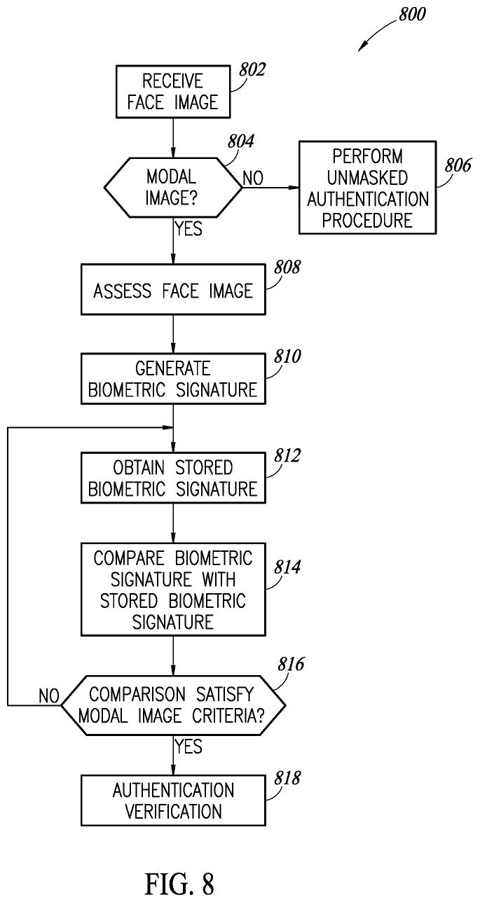

FIG. 8 shows a method 800 for authenticating or identifying a person depicted in a face image that includes protective equipment according to one or more embodiments. The method 800 is performed by the system 100 as described with respect to FIG. 5. The method 800 includes receiving 802 a face image of the person who is wearing protective equipment, such as the image 506. Receiving 802 may include extracting or identifying a face image in an image received. The face image may be received from a camera coupled to the system 100 or received from an external system requesting identification or authentication of a person shown in the face image. The face image, for example, may be received over one or more networks, such as the Internet or Local Access Network.

The method 800 also includes determining 804 whether the face image is a modal image. In particular, the system 100 determines whether an article of protective equipment (e.g., the protective equipment 512) is worn on a face of a person depicted in the face image received in 802. If the system 100 determines, in 804, that the face image does not include protective equipment, method 800 continues by performing an unmasked authentication procedure in which a biometric signature of the face image is compared with stored biometric signatures of unmasked face images. On the other hand, if the system determines in 804 that the face image received in 802 is a modal image that includes protective equipment, the method 800 proceeds to assess 808 the face image.

Assessing the face image in 808 includes assessing various characteristics of the face image to determine whether the face image satisfies a set of criteria for biometric signature authentication. For example, as described with respect to the assessment 510, assessing the face image in 808 may involve assessment of various factors, including the size of the face image, the pose or orientation of the face in the face image, the sharpness of the face image, and/or the contrast quality of the face image. The system 100 may generate image assessment information based on the result of the assessment in 808 and evaluate the image assessment information to determine whether to advance the face image 508 for further processing.

The system 100 may evaluate whether the face image satisfies minimum standards for one or more of the foregoing factors. The minimum standards for assessing the face image are different than the minimum standards for evaluating an image of an unmasked face due, e.g., to the reduced amount of information available in the face image. As a result of determining that the face image does not satisfy the set of criteria, the system 100 may discontinue the method 800. If, on the other hand, the face image satisfies the set of criteria, the method 800 proceeds to generating 810 a biometric signature of the face image.

Generating 810 a biometric signature may include providing the face image to a neural network that is trained to generate biometric signatures of images of faces. In some embodiments, the neural network may be particularly trained to generate biometric signatures of images of faces wearing protective equipment. The neural network provides, in response to receiving the face image, a biometric signature.

Next, the method 800 involves comparing stored biometric signatures with the biometric signature generated in 810. In particular, the stored biometric signatures include biometric signatures generated from images of faces wearing protective equipment. The system 100 obtains 812 a stored biometric signature from data storage and compares 814 the biometric signature obtained with the biometric signature generated in 810. The comparison 814 may involve determining a difference between the biometric signatures—for example, Euclidean distances between the biometric signatures.

In 816, the method 800 includes determining whether the biometric signature obtained from data storage satisfies modal image criteria with respect to the biometric signature generated in 810. For instance, the modal image criteria may include a similarity criterion involving distance between the biometric signatures. The modal image criteria may include thresholds that are stricter (e.g., involve a smaller distance threshold) than criteria for evaluating a comparison between biometric signatures of images of faces that do not include protective equipment. If the system 100 determines, in 816, that a result of the comparison 814 does not satisfy the modal image criteria, the system 100 returns to 812 and obtains another stored biometric signature for comparison with the biometric signature generated in 810.

If the comparison is determined as satisfying the modal image criteria in 816, the person in the face image is identified in 818. For instance, the face image is determined as corresponding to an identity associated with the stored biometric signature obtained in 812. The system 100 may identify the person imaged or evaluate other information associated with the identity—for example, whether the person has sufficient permissions to access a restricted area.

In some embodiments, the operations in 812, 814, and 816 may be performed differently. As one non-limiting example, obtaining 812, comparing 814, and determining 816 may include performing a database query or fuzzy hashing algorithm to identify candidate biometric signatures that are within a defined similarity threshold. In some embodiments, a neural network may be trained to evaluate the similarity of biometric signatures to determine a match.

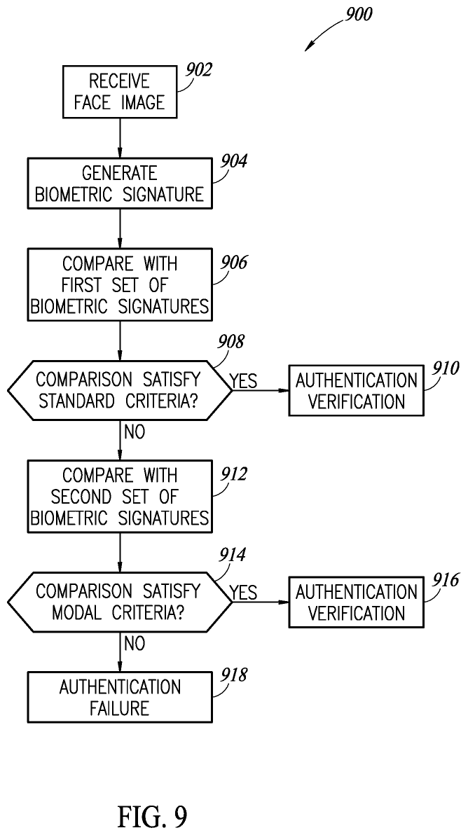

FIG. 9 shows a method 900 for authenticating or identifying a person depicted in a face image that includes protective equipment according to one or more embodiments. The method 900 is performed by the system 100 as described with respect to FIG. 6. Various operations described with respect to the method 900 are substantially similar to features described with respect to the method 800, so further description thereof is omitted for brevity.

The method 900 includes receiving 902 a face image of the person who is wearing protective equipment, such as the image 506. The method 900 also includes generating 904 a biometric signature of the face image received and comparing 906 the biometric signature with a plurality of stored biometric signatures. For example, the stored biometric signatures include biometric signatures generated using images of faces that do not include protective equipment, such as the stored biometric signatures 604 described with respect to FIG. 6. The system 100 may compare 906 the signature generated in 904 with the plurality of stored biometric signatures. At 908, the method 900 includes determining whether a result of the comparison in 906 satisfies a set of standard criteria for determining a match between biometric signatures, such as whether similarity between a stored biometric signature and the generated biometric signature is within a certain numerical range. If so, the method 900 proceeds to identify or authenticate 910 the identity of the person depicted in the image.

If, on the other hand, the system 100 determines that the comparisons do not satisfy the standard criteria, the method 900 proceeds to compare 912 the biometric signature generated in 904 with a second set of stored biometric signatures. The stored biometric signatures in 912 include biometric signatures generated using images of faces that include protective equipment, such as the stored biometric signatures 610 discussed with respect to FIG. 6. At 914, the method 900 includes determining whether result of the comparison in 912 satisfies a set of modal criteria for determining a match between biometric signatures, such as whether similarity between a stored biometric signature and the generated biometric signature is within a certain numerical range. The set of modal criteria used in 914 may involve stricter standards than the set of standard criteria involved in 908—for example, the set of modal criteria may specify a smaller distance threshold or range than the set of standard criteria.

If it is determined in 914 that a result of the comparison in 912 satisfies the modal criteria, then the method 900 proceeds to identify or authenticate 916 the identity of the person depicted in the image. For example, the face image is determined as corresponding to an identity of the person associated with the stored biometric signature that satisfies the set of modal criteria with respect to the biometric signature generated in 904. If none of the second set of stored biometric signatures satisfied the modal criteria in 914, then the system 100 determines the occurrence of an authentication failure 918. That is, the biometric signature generated in 904 does not correspond to any known identities associated with the first set of biometric signatures in 906 or the second set of biometric signatures in 912.

The method 900 may also include assessing the various characteristics of the face image received in 902 relative to various criteria to ensure that characteristics of the face image are sufficient to confidently determine a match. Assessing the face image may involve, as a condition precedent to comparing the biometric signature generated in 904 with stored biometric signatures, verifying that the size of the face image, the pose of the face in the face image, the sharpness of the face image, and the contrast quality of the face image are sufficient for evaluation of a biometric signature. The set of criteria may include a first set of thresholds for evaluating the face image prior to comparison with the first set of biometric signatures in 906. The set of criteria may also include a second set of thresholds for evaluating the face image prior to comparison with the second set of biometric signatures in 912. The second set of thresholds include different thresholds than the first set of thresholds. For example, the second set of thresholds may involve smaller numerical thresholds or ranges for the characteristics of the face image. Various operations involved in the method 900 may be performed using or in connection with a neural network.

The various embodiments described above can be combined or modified to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

This application claims the benefit of priority to U.S. Provisional Application No. 63/008,526, filed Apr. 10, 2020, which application is hereby incorporated by reference in its entirety.

1. A method, comprising:
receiving a first face image;
combining a mask image with the first face image to obtain a second face image;
generating a first biometric signature of the second face image;
storing the first biometric signature in association with identification information; and
using the first biometric signature to identify a person in an image.

2. The method of claim 1, wherein the mask image is an image of a respiration mask or an image of a respirator.

3. The method of claim 1, comprising:
determining a defined region of the first face image; and
superimposing the mask image over the first face image within the defined region.

4. The method of claim 3, wherein the defined region is between a bridge of a nose of the first face image and a chin of the first face image.

5. The method of claim 3, comprising:
determining a first edge of the defined region along a line between a nose bridge in the first face image and a nose tip in the first image;
determining a second edge of the defined region relative to a chin of the first face image; and
determining a third edge and a fourth edge of the defined region relative to edges of cheeks in the first face image.

6. The method of claim 1, comprising:
receiving a third face image;
generating a second biometric signature of the third face image;
calculating a difference between the first biometric signature and the second biometric signature;
comparing the difference to a first set of criteria for authentication; and
as a result of the difference satisfying a defined threshold, determining that the third face image corresponds to the identity.

7. The method of claim 6, comprising:
assessing whether one or more characteristics of the first face image satisfy a second set of criteria, wherein determining that the third face image corresponds to the identity is as a result of confirming that the one or more characteristics of the first face image satisfy the second set of criteria.

8. The method of claim 7, wherein the second set of criteria include criteria involving one or more characteristics of a size of the first face image, a pose of a face in the first face image, a sharpness of the first face image, and a contrast quality of the first face image.

9. The method of claim 1, wherein superimposing the mask image includes providing the first face image to a neural network trained to generate a new image by superimposing an object image on a target image.

10. The method of claim 9, wherein the neural network is a generative adversarial network or a variational autoencoder.

11. A system, comprising:
one or more processors; and
memory coupled to the one or more processors and storing instructions that, as a result of execution by the one or more processors, cause the system to:
receive a first face image;
obtain a mask image from data storage;
combine the mask image with the first face image to obtain a second face image;
generate a first biometric signature of the second face image;
store the first biometric signature in association with identification information; and
authenticate an identity of a person in an image using the first biometric signature.

12. The system of claim 11, wherein execution of the instructions causes the system to:
determine a defined region of the first face image; and
superimpose the mask image over the first face image within the defined region.

13. The system of claim 12, wherein execution of the instructions causes the system to:
determine a first edge of the defined region along a line between a nose bridge in the first face image and a nose tip in the first image;
determine a second edge of the defined region relative to a chin of the first face image; and
determine a third edge and a fourth edge of the defined region relative to edges of cheeks in the first face image.

14. The system of claim 11, comprising:
a neural network trained to combine the mask image with the first face image to obtain the second face image.

15. The system of claim 11, wherein execution of the instructions causes the system to:
receive a third face image;
generate a second biometric signature of the third face image;
calculate a difference between the first biometric signature and the second biometric signature;
compare the difference to a first set of criteria for authentication; and
as a result of the difference satisfying a defined threshold, determine that the third face image corresponds to the identity.

16. The system of claim 11, wherein the mask image is an image of personal protective equipment.

17. A non-transitory computer-readable medium storing instructions that, as a result of execution by one or more processors, cause the one or more processors to:
receive a first face image;
obtain a mask image from data storage;
superimpose the mask image on a defined region of the first face image to obtain a second face image;
generate a first biometric signature of the second face image;
store the first biometric signature in association with identification information; and
authenticate an identity of a person in an image using the first biometric signature.

18. The non-transitory computer-readable medium of claim 17, wherein execution of the instructions causes the one or more processors to:
receive a third face image captured by a camera, the third face image not including an image of protective equipment;
generate a second biometric signature of the third face image;
calculate a difference between the first biometric signature and the second biometric signature;
compare the difference to a first set of criteria for authentication; and
as a result of the difference satisfying a defined threshold, determine that the third face image corresponds to the identity.

19. The non-transitory computer-readable medium of claim 17, wherein execution of the instructions causes the one or more processors to:
assess whether one or more characteristics of the first face image satisfy a set of criteria, wherein the first biometric signature is stored as a result of confirmation that the one or more characteristics of the first face image satisfy the set of criteria.

20. The non-transitory computer-readable medium of claim 17, wherein execution of the instructions causes the one or more processors to:
determine a defined region of the first face image, wherein the mask image is superimposed over the first face image within the defined region.
